(19) United States
(12) Patent Application Publication
(10) Pub. No.: US 2012/0022959 A1
(43) Pub. Date: Jan. 26, 2012

(54) EVENT-RELEVANT CONTENT MACHINE

(76) Inventors: Steve Yankovich, San Jose, CA (US); Ryan Melcher, Ben Lomond, CA (US)

(21) Appl. No.: 12/842,858

(22) Filed: Jul. 23, 2010

(51) Int. Cl. G06F 15/16; G06Q 30/00

(52) U.S. Cl. 705/26.1; 709/203

(57) ABSTRACT

A content machine generates content for a particular user of a network-based publication system and provides the content to a client machine configured to present the content to the particular user. The content generated by the content machine is generated based on information accessed by the content machine, and the content may include some or all of the information accessed. The information may include social network data of the particular user, event data referencing an event to occur on an event date, a transactional record of the particular user, a transactional record of a further user, client location data corresponding to the client machine, merchandising data referencing an item listed by the network-based publication system, or any suitable combination thereof.

### TECHNICAL FIELD

The subject matter disclosed herein generally relates to the processing of data. Specifically, the present disclosure addresses systems and methods of providing event-relevant content.

### BACKGROUND

Content may be provided over a network from a content machine to a client machine. The content machine may be a server machine (e.g., a web server machine, a database server machine, or a listing server machine). For example, a network-based publication system may include a web server machine that provides content over a network to a client machine.

The client machine may be a computer, a mobile device, or other machine functioning, temporarily or permanently, as a client in relation to the content machine. For example, the client machine may have a user. The user may be a human user or a machine-implemented user (e.g., software executing on the client machine). The content provided by the content machine may be presented to the user by the client machine.

### BRIEF DESCRIPTION OF THE DRAWINGS

Some embodiments are illustrated by way of example and not limitation in the figures of the accompanying drawings in which:

FIG. 1 is a network diagram illustrating a system including a content machine, according to some example embodiments;

FIG. 2 is a block diagram of a content machine, according to some example embodiments;

FIG. 3 is a block diagram of event data, according to some example embodiments;

FIG. 4 is a block diagram of client location data, according to some example embodiments;

FIG. 5 is a block diagram of a transactional record of a user, according to some example embodiments;

FIG. 6 is a block diagram of social network data of a user, according to some example embodiments;

FIG. 7-8 are diagrams of example content provided by the content machine, according to some example embodiments;

FIG. 9 is a flow chart illustrating operations in a method of providing content, according to some example embodiments; and

FIG. 10 is a block diagram illustrating components of a machine, according to some example embodiments, able to read instructions from a machine-readable medium and perform any one or more of the methodologies discussed herein.

### DETAILED DESCRIPTION

Example methods and systems are directed to providing event-relevant content. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A network-based publication system has a database that stores information pertinent to one or more users of the network-based publication system. A content machine is communicatively coupled to the network-based publication system and to one or more client machines via a network.

The content machine generates content for a particular user of the network-based publication system and provides the content to a client machine. The client machine is configured to receive the content via the network and present the content to the particular user.

The content generated by the content machine is generated based on information (e.g., data) accessed by the content machine, as described below. Some or all of the information may be stored in the database of the network-based publication system and accessed by the content machine during or prior to generation of the content.

One type of data accessed by the content machine is event data. The content machine accesses event data that is relevant to the particular user of the network-based publication system. The event data references an event to occur on an event date, and the event data may include the event date and an event name. For example, the event data may include an event name of “New Year's Eve party” and an event date of “Dec. 31, 2018.” As another example, the event data may include an event name of “Wedding Anniversary” and an event date of “May 12.” As a further example, the event data may include an event name of “camping trip” and “July 3-6” as a range of event dates that, in turn, includes “July 4” as an event date. The content machine may utilize the event data in generating the content for the particular user.

Another type of data accessed by the content machine is social network data. The content machine accesses social network data of the particular user. The social network data includes a reference to a further user of the network-based publication system. For example, the social network data may include a name (e.g., “John Smith”) as the reference to the further user. As another example, the social network data may include a username (e.g., “jsmith2008”) as the reference to the further user. As a further example, the social network data may include an alphanumeric identifier (e.g., “2008PXM72810”) as the reference to the further user. Moreover, the social network data may include a relationship identifier (e.g., “friend,” “spouse,” or “coworker) that describes a relationship between the particular user and the further user. The content machine may utilize the social network data in generating the content for the particular user.

The content machine may also access one or more transactional records corresponding to one or more users of the network-based publication system. A transactional record includes purchase data of a user (e.g., the particular user). The purchase data includes a reference to an item purchased by the user and may be generated by the network-based publication system in facilitating the purchase of the item by the user. Any number of transactional records may be stored in the database of the network-based publication system. The content machine may access a transactional record of the particular user, a transactional record of the further user, or both. The content machine may utilize one or more of these transactional records in generating the content for the particular user.

Moreover, the content machine may access geo-location information in the form of client location data, the event location data, or any suitable combination thereof. The geo-location information may include a street name, a city name, a venue name, a neighborhood name, a latitude value, a longitude value, or any suitable combination thereof. The event location data identifies a geographical location corresponding to the event and may be included in the event data. The client location data identifies a further geographical location that corresponds to the client machine configured to present the content to the particular user. The content machine may utilize the event location data, the client location data, or both, in generating the content for the particular user.

Furthermore, the content machine may access merchandising data (e.g., an advertisement or promotion) that references a further item. The further item may be listed by the network-based publication system as being available for purchase. The merchandising data includes an item name of the further item and may include the event name, the event date, or any suitable combination thereof. For example, the merchandising data may include “14 k diamond tennis bracelet” as the item name and include “wedding anniversary” as the event name. As another example, the merchandising data may include “fire extinguisher” as the item name and include “July 4” as the event date. The content machine may utilize the merchandising data in generating the content for the particular user.

Accordingly, the content machine may generate the content for the particular user using information that includes the event data, the social network data, the transactional record of the particular user, the transactional record of the further user, the client location data, the merchandising data, or any suitable combination thereof. Some or all of this information may be received by the content machine (e.g., from the database of the network-based publication system, from a web server machine of the network-based publication system, or from a client machine) via the network. Once the content is generated, the content machine provides the content to the client machine that is configured to present the content to the particular user.

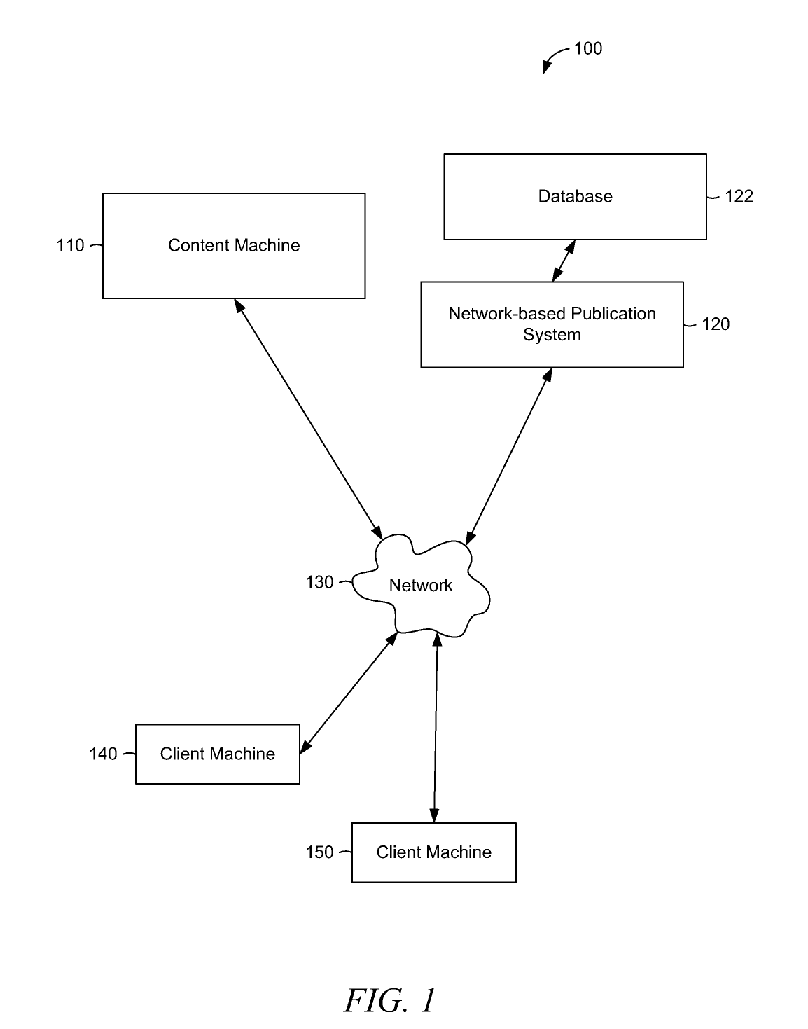

FIG. 1 is a network diagram illustrating a system 100, according to some example embodiments. The system 100 includes a content machine 110, a network-based publication system 120, a database 122 of the network-based publication system 120, and client machines 140 and 150, all coupled to each other via a network 130.

The network-based publication system 120 may include one or more server machines (e.g., web server machines) configured to communicate with one or more machines (e.g., the content machine 110 or the client machine 140) via the network 130. In various example embodiments, the content machine 110 may be internal or external to the network-based publication system 120. Similarly, the database 122 may be internal or external to the network-based publication system 120. For example, the database 122 may be managed by a database server machine, and the database server machine may be internal or external to the network-based publication system 120.

The database 122 is a database storage facility that that provides access to information stored thereon. For example, the database 122 may be implemented using a data file, a table, a relational database, a triple store, or any suitable combination thereof.

The client machine 140 corresponds to a particular user of the network-based publication system 120 and is configured to communicate information with the particular user (e.g., to present content to the particular user). Similarly, the client machine 150 corresponds to a further user of the network-based publication system 120 and is configured to communicate information with the further user.

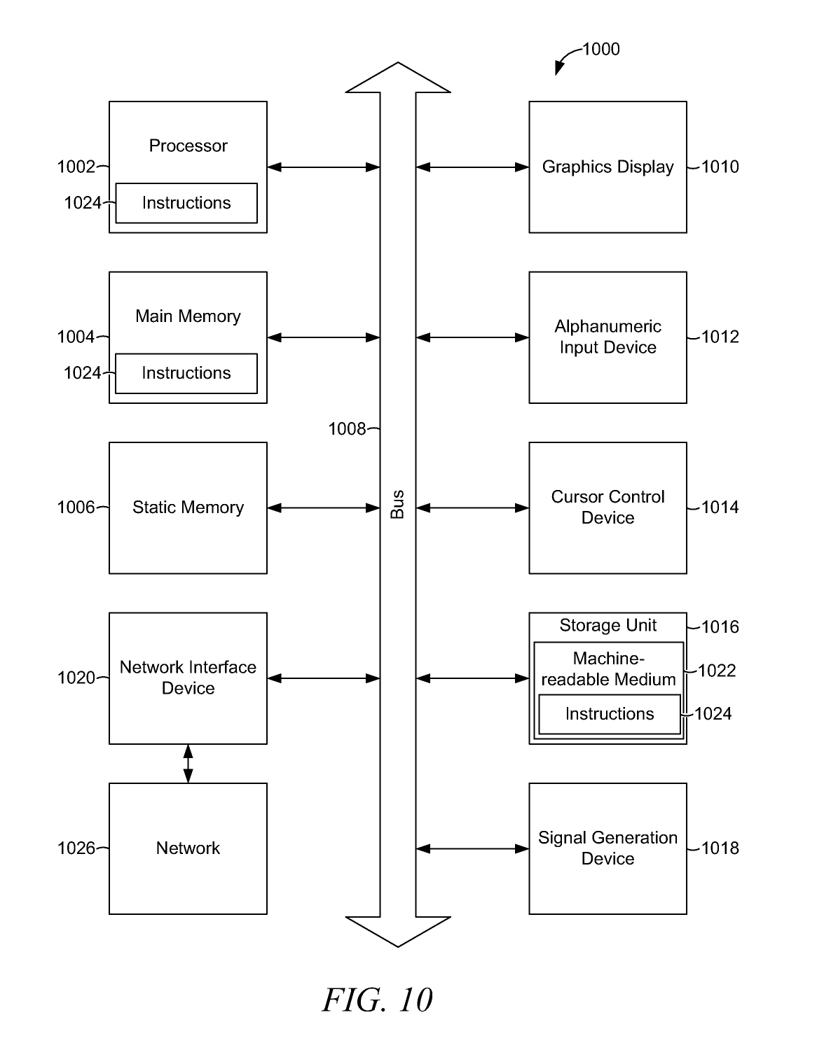

Any of the machines shown in FIG. 1 may be implemented in a general-purpose computer modified (e.g., programmed) by special software to be a special-purpose computer able to perform the functions described herein for that machine. The computer may form all or part of a machine of any size, including, a personal computer, a mobile device (e.g., a smart phone), a kiosk display, a wristwatch, an information panel, a theatrical display, a billboard, or any suitable combination thereof. For example, a computer system able to implement any one or more of the methodologies described herein is discussed below with respect to FIG. 10. Moreover, any two or more of the machines illustrated in FIG. 1 may be combined into a single machine, and the functions described herein for any single machine may be subdivided among multiple machines.

The network 130 may be any network that enables communication between machines (e.g., the content machine 110 and the client machine 140). Accordingly, the network 130 may be a wired network, a wireless network, or any suitable combination thereof. The network 130 may include one or more portions that constitute a private network, a public network (e.g., the Internet), or any suitable combination thereof.

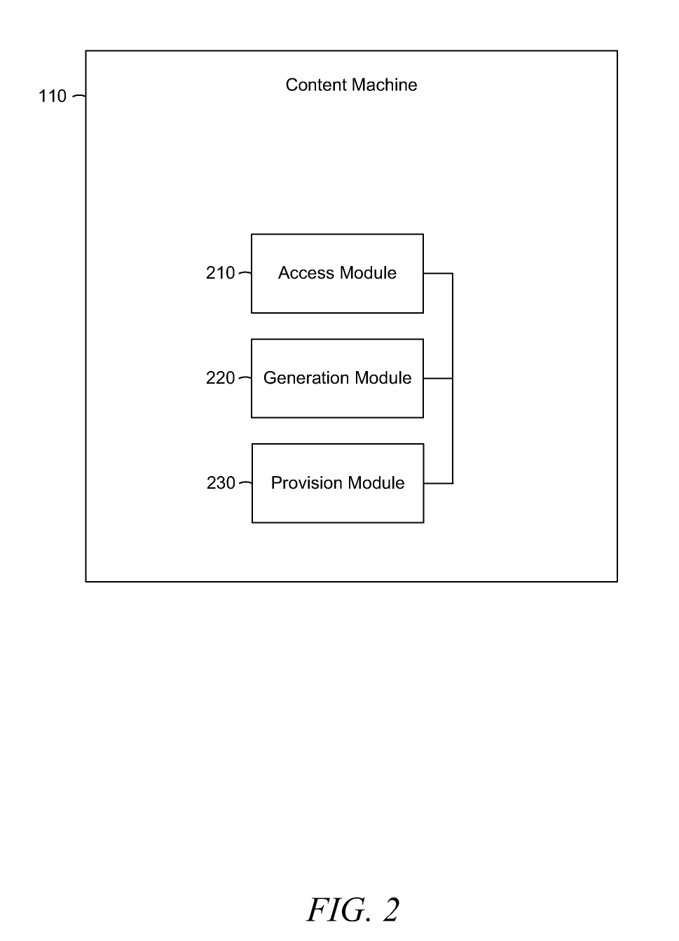

FIG. 2 is a block diagram of the content machine 110, according to some example embodiments. The content machine 110 includes an access module 210, a generation module 220, and a provision module 230, all configured to communicate with each other (e.g., via a bus, a shared memory, or a switch). Any of these modules may be implemented using hardware or a combination of hardware and software. Moreover, any two or more of these modules may be combined into a single module, and the functions described herein for a single module may be subdivided among multiple modules.

The access module 210 is configured to access information to be used in generating the content for the particular user. Accordingly, the access module 210 may access event data. The event data is relevant to a particular user of the network-based publication system 120. For example, the event data may include all or part of an online calendar corresponding to the particular user and stored in the database 122. As another example, the event data may be received by the access module 210 as a result of the particular user submitting the event data to the content machine 110, the network-based publication system 120, or both. As a further example, the event data may be received by the access module 210 from a calendar application executing on the client machine 140.

The access module 210 may access social network data of the particular user (e.g., a first user). The social network data includes a reference to a further user (e.g., a second user). In various example embodiments, the particular user is distinct from the further user. As an example, the database 122 may store the social network data, and the access module 210 may access the social network data by communicating with the database 122. As another example, the access module 210 may receive the social network data from the client machine 140. As a further example, the access module 210 may receive the social network data from the network-based publication system 120 (e.g., from a web server machine within the network-based publication system 120). As yet another example, the access module 210 may receive the social network data from a database external to the network-based publication system 120 (e.g., hosted by a third-party server machine). Specifically, a third-party server machine may provide a social networking service (e.g., Facebook®) to millions of users and provide the social network data to the access module 210.

The access module 210 may access one or more transactional records of the network-based publication system 120. The transactional records may be stored in the database 122. A transactional record includes purchase data that corresponds to a user of the network-based publication system 120 (e.g., the particular user or the further user). The purchase data includes a reference to an item that was previously purchased by the user. The purchase data may be generated by the network-based publication system 120 in facilitating the purchase. Accordingly, the access module 210 may access a transactional record of the particular user (e.g., including first purchase data corresponding to a purchase of an item), a transactional record of the further user (e.g., including second purchase data corresponding to a purchase of another item), or both. As an example, the database 122 may store one or more transactional records, and the access module 210 may access the one or more transactional records by communicating with the database 122. As another example, the access module 210 may receive one or more transactional records from the network-based publication system 120. As a further example, the access module 210 may receive one or more transactional records from the client machine 140.

Moreover, the access module 210 may access client location data that corresponds to the client machine 140. The client location data identifies a geographical location of the client machine 140 and may include a street name, a city name, a venue name, a neighborhood name, a latitude value, a longitude value, or any suitable combination thereof. As an example, the database 122 may store the client location data, and the access module 210 may access the client location data by communicating with the database 122. As another example, the access module 210 may receive the client location data from the network-based publication system 120. As a further example, the access module 210 may receive the client location data from the client machine 140. In some example embodiments, the client location data is generated by a global positioning system (GPS) interface module within the client machine 140 and communicated from the client machine 140 to the access module 210. In various example embodiments, the client location data is stored, temporarily or permanently, by the network-based publication system 120 (e.g., in the database 122).

Furthermore, the access module 210 may access merchandising data that references an item (e.g., a further item). For example, the merchandising data may include an advertisement or promotion pertinent to the item. The item may be listed by the network-based publication system 120 as being available for purchase (e.g., by the particular user). As noted above, the merchandising data includes an item name of the item and may include the event name, the event date, or any suitable combination thereof. As an example, the database 122 may store the merchandising data, and the access module 210 may access the merchandising data by communicating with the database 122. As another example, the access module 210 may receive the merchandising data from the network-based publication system 120. As a further example, the access module may receive the merchandising data from a client machine (e.g., client machine 150) as a result of a user (e.g., a further user) submitting the merchandising data.

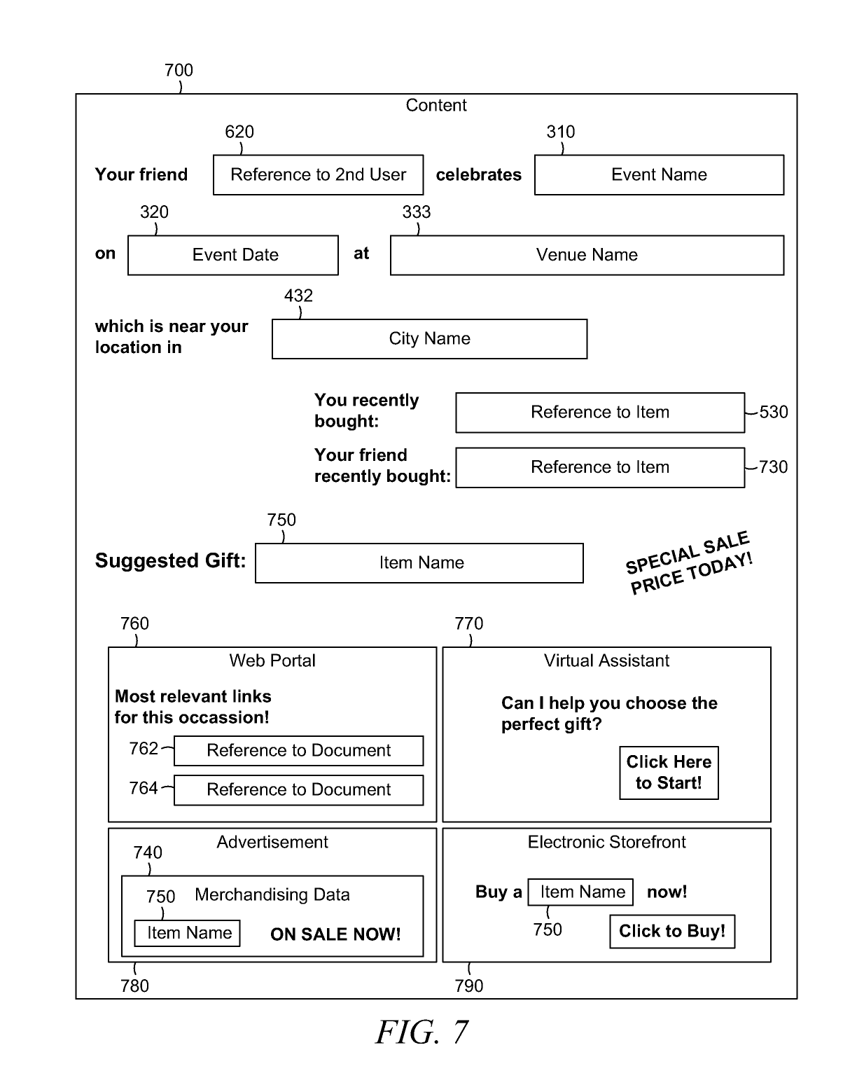

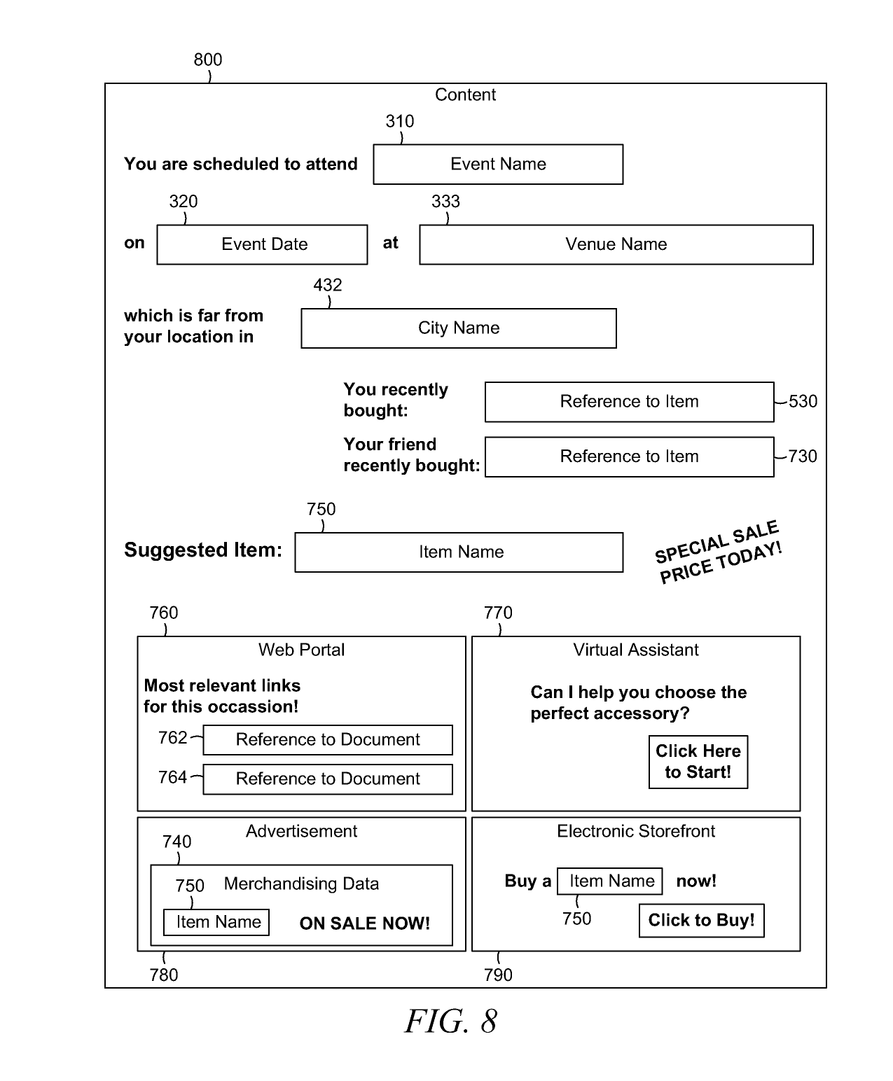

The generation module 220 is configured to generate the content for the particular user of the network-based publication system 120. The generation module 220 generates the content based on some or all of the information accessed by the access module 210. Accordingly, the content generated by the generation module 220 may include some or all of the information accessed by the access module 210. Examples of content are discussed below with respect to FIG. 7-8.

The provision module 230 is configured to provide the content to the client machine 140, which is configured to present the content to the particular user of the network-based publication system 120. As an example, the provision module 230 may communicate the content to the client machine 140 via the network 130. As another example, the provision module 230 may communicate the content to the network-based publication system 120 for relaying to the client machine 140 (e.g., as part of a bundle of content).

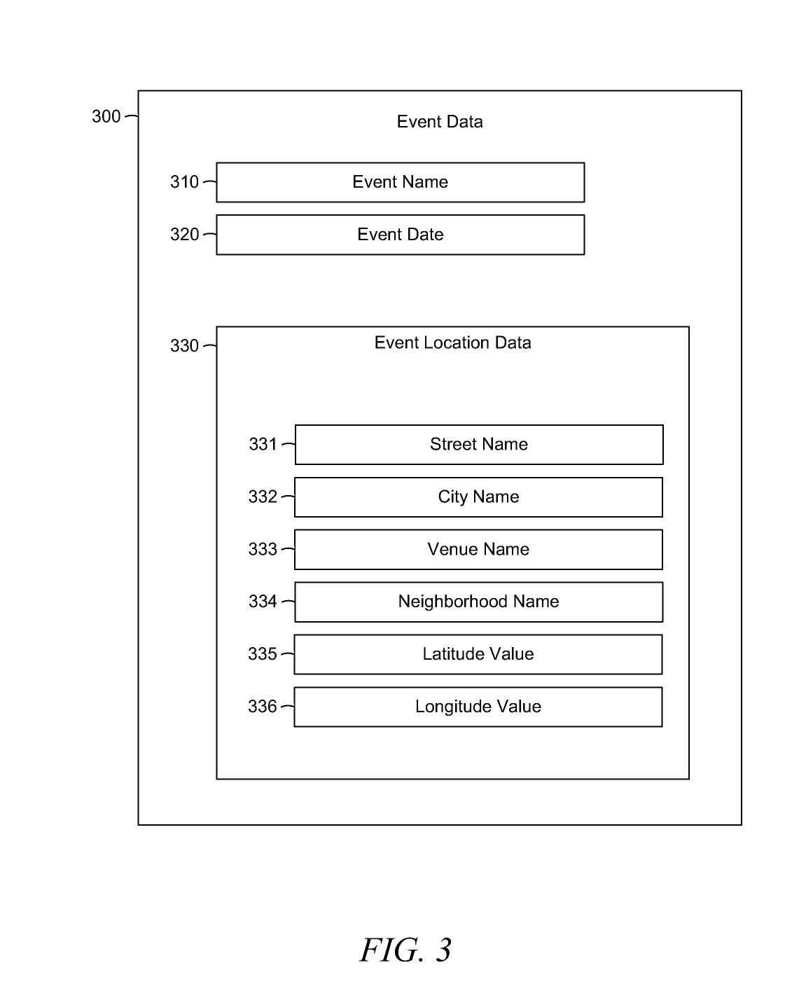

FIG. 3 is a block diagram of event data 300, according to some example embodiments. The event data 300 is a data structure that includes an event name 310, an event date 320, and event location data 330. The event data 300 may be stored in the database 122, the network-based publication system 120, or any suitable combination thereof. In various example embodiments, the event data 300 includes multiple event dates (e.g., a range of event dates). The event data 300 is relevant to the particular user of the network-based publication system 120 and references an event to occur on the event date 320. The event is identifiable by the event name 310 and may be any event of significance to the particular user. In various example embodiments, the event may be: a public event (e.g., a government holiday), a private event (e.g., a birthday or an anniversary), a personal event (e.g., a deadline to take an action), an educational event (e.g., a lecture or an examination), an entertainment event (e.g., a concert or a festival), a religious event (e.g., a ritual), a sports event (e.g., a tournament or a sports season), an astronomical event (e.g., an eclipse, a moon phase, a solstice, or an equinox), a transportation event (e.g., a departure or an arrival), a calendar event (e.g., the first day of a month), or any suitable combination thereof.

The event location data 330 identifies a geographical location that corresponds to the event and may include any form of location data. As an example, the event location data 330 may identify a geographical location where the event is to occur. As another example, the event location data 330 may identify a geographical location where detailed information pertaining to the event may be obtained. Accordingly, the event location data 330 may include: a street name 331, a city name 332, a venue name 333, a neighborhood name 334, a latitude value 335, a longitude value 336, or any suitable combination thereof. For example, the venue name 333 may identify a facility at which the event is to occur, and the street name 331 may form part of an address of that facility. As another example, the latitude value 335 and the longitude value 336 may constitute global positioning system (GPS) coordinates of the geographical location corresponding to the event.

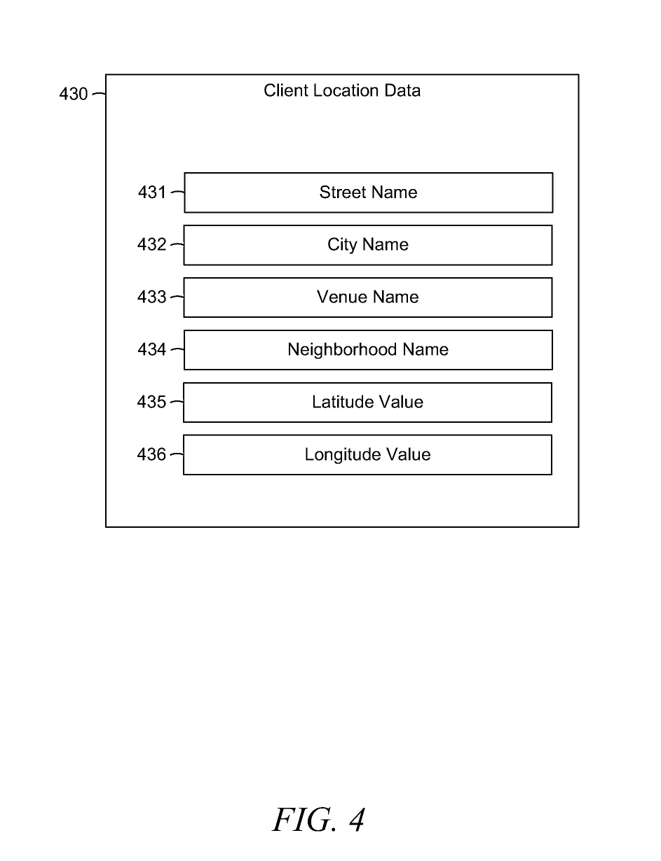

FIG. 4 is a block diagram of client location data 430, according to some example embodiments. The client location data 430 may be stored in the database 122, the network-based publication system 120, the client machine 140, or any suitable combination thereof.

The client location data 430 identifies a geographical location that corresponds to the client machine 140 and may include any form of location data. The client location data 430 may include: a street name 431, a city name 432, a venue name 433, a neighborhood name 434, a latitude value 435, a longitude value 436, or any suitable combination thereof. For example, the neighborhood name 434 may identify a regional area in which the client machine 140 is located, and the city name 432 may identify a city that encompasses that regional area. As another example, the latitude value 435 and a longitude value 436 may constitute GPS coordinates of the geographical location corresponding to the client machine 140.

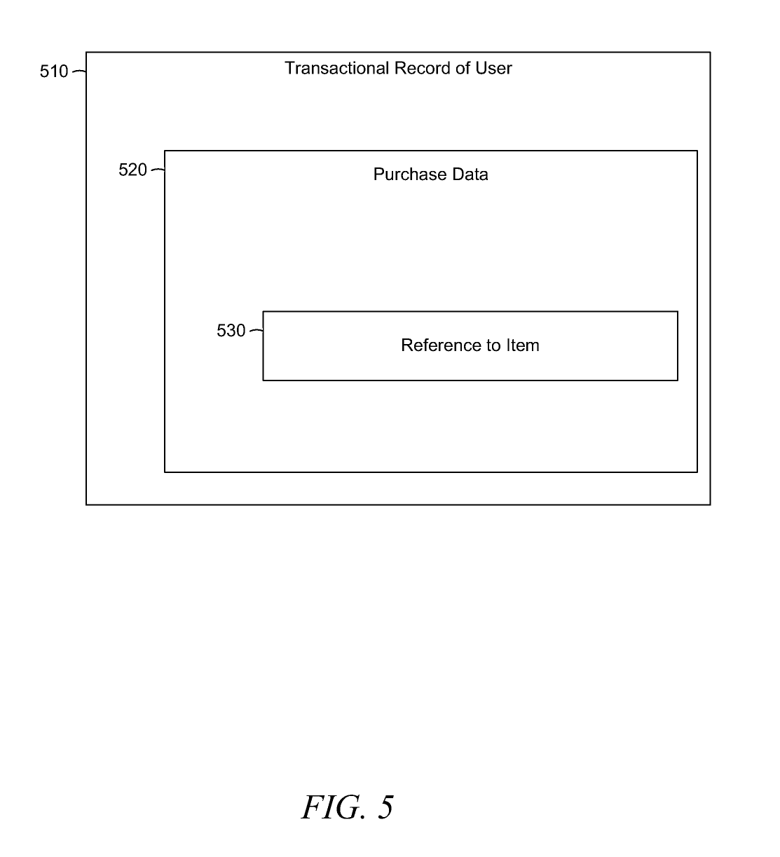

FIG. 5 is a block diagram of a transactional record 510 that corresponds to a user (e.g., the particular user or the further user) of the network-based publication system 120, according to some example embodiments. The transactional record 510 may be stored in the database 120, the network-based publication system 120, or any suitable combination thereof.

The transactional record 510 includes purchase data 520. The purchase data 520 includes a reference 530 to an item previously purchased by the user (e.g., the particular user or the further user). The item may have been presented (e.g., listed) by the network-based publication system 120 as being available for purchase (e.g., by the user) or otherwise subject to a purchase facilitated by the network-based publication system 120. Moreover, the item may be a specimen of a product (e.g., a copy of a book) presented as being available for purchase. In various example embodiments, the network-based publication system 120 facilitates the purchase of the item, and the purchase data 520 is generated by the network-based publication system 120 in facilitating the purchase. For example, the network-based publication system 120 may process some or all of the purchase (e.g., receive a payment for the item or authorize delivery of the item). As another example, the network-based publication system 120 may process communications between the user and a seller of the item (e.g., as part of an auction service). Accordingly, the transactional record 510 may serve to document the previous purchase of the item by the user.

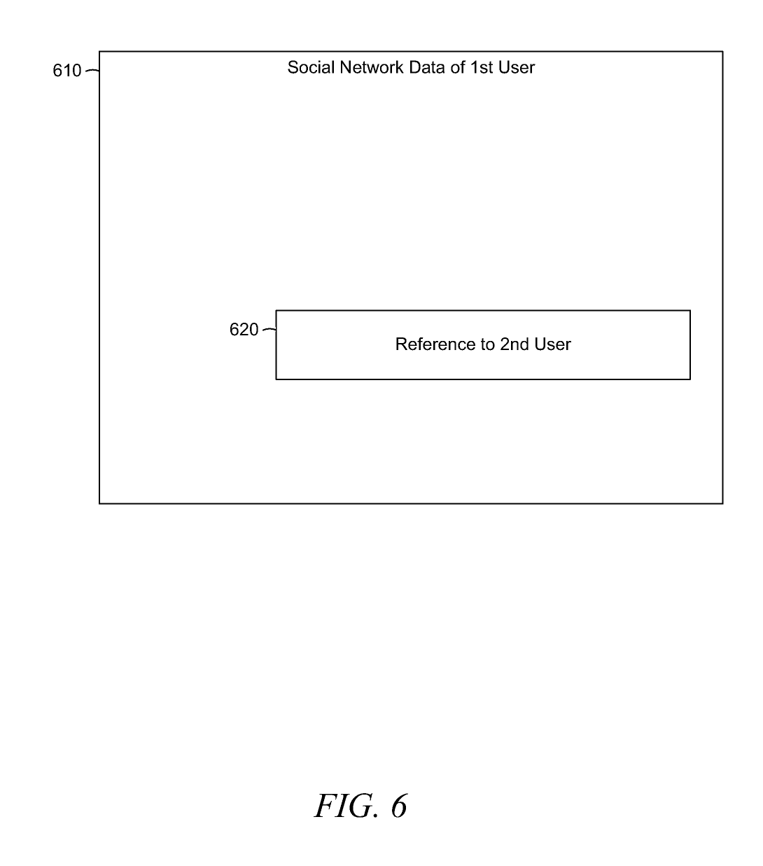

FIG. 6 is a block diagram of social network data 610 of the particular user (e.g., a first user) of the network-based publication system 120, according to some example embodiments. The social network data 610 may be stored in the database 122, the network-based publication system 120, the client machine 140, the client machine 150, a third-party database (e.g., operated by a social networking service), or any suitable combination thereof.

The social network data 610 includes a reference 620 to a further user (e.g., a second user) of the network-based publication system 120 and may include any form of identification of the further user. For example, the social network data 610 may correspond to a particular user of the network-based publication system 120, and the reference 620 refers to the further user of the network-based publication system 120. As noted above, the reference 620 may include a name, a username, a pen alphanumeric identifier, or any suitable combination thereof, corresponding to the further user. Moreover, the social network data 610 may include a relationship identifier that identifies a relationship between the particular user and the further user.

FIG. 7 is a diagram of content 700 provided by the content machine 110 to the client machine 140, according to some example embodiments. The content 700 is generated by the generation module 220 of the content machine 110 and provided by the provision module 230 of the content machine 110. The generation module 220 may generate the content 700 based on some or all of the information accessed by the access module 210 of the content machine 110. The content 700 is generated for the particular user (e.g., the first user) of the network-based publication system 120.

The content 700 includes at least some of the social network data 610. As shown, the reference 620 to the further user (e.g., the second user) is included in the content 700.

Moreover, the content 700 includes at least some of the event data 300. As shown, the event name 310, the event date 320, and the venue name 333 from the event location data 330 are included in the content 700.

Additionally, the content 700 includes at least some of the client location data 430. As shown, the city name 432 from the client location data 430 is included in the content 700.

Furthermore, the content 700 includes at least some purchase data (e.g., purchase data 520) from a transactional record (e.g., transactional record 510). As shown, the reference 530 to an item purchased by the particular user is included in the content 700. Also, a further reference 730 to a further item purchased by the further user is included in the content 700. The further reference 730 may form all or part of a further purchase data that is included in a further transactional record corresponding to the further user.

In addition, the content 700 may include an item name 750 of an item listed by the network-based publication system 120. The item name 750 is included in merchandising data 740 that references the item listed. As shown, the merchandising data 740 appears in an advertisement 780 within the content 700 and includes the item name 750. The merchandising data 740 may further include at least one of the event name 310 or the event date 320, which need not be shown in the content 700. By relating the item name 750 to the event name 310 or event date 320, the merchandising data 740 identifies the item as being pertinent to the event (e.g., suggested, recommended, or appropriate). For example, the content 700 may include a suggestion that the item be purchased as a gift (e.g., for the further user by the particular user) in connection with the event. As shown, the item name 750 appears in the content 700 as a suggested gift.

The content 700 may include one or more additional information components. As shown, the content 700 includes a web portal 760, a virtual assistant 770, the advertisement 780, and an electronic storefront 790.

The web portal 760 includes references 762 and 764 to documents presented as being relevant to the event corresponding to the event name 310. The references 762 and 764 may be hyperlinks to the documents. The documents may be available from network-based publication system 120 (e.g., from a web server machine of the network-based publication system 120). For example, the documents may be web pages that present one or more listings of items.

The virtual assistant 770 is a user interface operable (e.g., using the client machine 140) to facilitate a selection from among a plurality of items listed by the network-based publication system 120. For example, the network-based publication system 120 may list twelve products of a particular type (e.g., digital cameras), and the virtual assistant 770 may be operable to assist the particular user (e.g., through use of the client machine 140) to navigate a decision tree of product features and make a selection of a particular product.

The advertisement 780 includes at least some of the merchandising data 740 to advertise an item listed by the network-based publication system 120. The item may be a specimen of a product presented by the network-based publication system 120 as being available for purchase. As shown, the advertisement 780 includes the merchandising data 740, which in turn includes the item name 750 of the item listed by the network-based publication system 120.

The electronic storefront 790 is a user interface operable (e.g., using the client machine 140) to facilitate a purchase (e.g., by the particular user) of the item listed by the network-based publication system 120. As shown, the electronic storefront 790 includes the item name 750 of the item listed.

FIG. 8 is an alternative diagram of content 800 provided by the content machine 110 to the client machine 140, according to some example embodiments. The content 800 is generated by the generation module 220 of the content machine 110 and provided by the provision module 230 of the content machine 110. The generation module 220 may generate the content 800 based on some or all of the information accessed by the access module 210 of the content machine 110. The content 800 is generated for the particular user (e.g., the first user) of the network-based publication system 120.

The content 800 includes at least some of the event data 300. As shown, the event name 310, the event date 320, and the venue name 333 from the event location data 330 are included in the content 800.

Moreover, the content 800 includes at least some of the client location data 430. As shown, the city name 432 from the client location data 430 is included in the content 800.

Additionally, the content 800 includes at least some purchase data (e.g., purchase data 520) from a transactional record (e.g., transactional record 510). As shown, the reference 530 to an item purchased by the particular user is included in the content 800. Also, the further reference 730 to the further item purchased by the further user is included in the content 800. The references 530 and 730 are described above with respect to FIG. 7.

Furthermore, the content 800 may include the item name 750 of the item listed by the network-based publication system 120. The item name 750 is included in the merchandising data 740 that references the item listed. As shown, the merchandising data 740 appears in the advertisement 780 and includes the item name 750. As noted above with respect to FIG. 7, the merchandising data 740 identifies the item as being pertinent to the event. Accordingly, the content 800 may include a suggestion that the item be purchased as a gift (e.g., for the further user by the particular user) in connection with the event. As shown, the item name 750 appears in the content 800 as a suggested gift.

The content 800 may include one or more additional information components. As shown, the content 800 includes the web portal 760, the virtual assistant 770, the advertisement 780, and the electronic storefront 790. The web portal 760, the virtual assistant 770, the advertisement 780, and the electronic storefront 790, are described above with respect to FIG. 7.

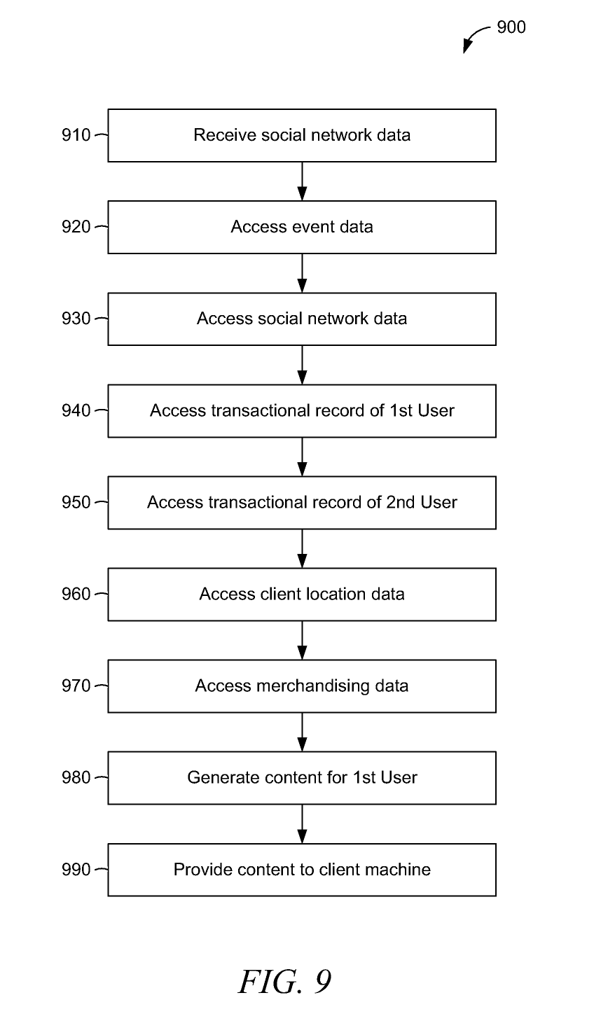

FIG. 9 is a flow chart illustrating operations 910-990 in a method 900 of providing content (e.g., content 700 or content 800), according to some example embodiments.

In operation 910, the access module 210 of the content machine 110 accesses (e.g., receives, retrieves, or reads) the social network data 610. The social network data 610 may be received from the database 122, the network-based publication system 120, the client machine 140, a database external to the network-based publication system 120 (e.g., hosted by a third-party server machine), or any suitable combination thereof.

In operation 920, the access module 210 of the content machine 110 accesses the event data 300. The event data 300 may be accessed from the database 122, the network-based publication system 120, the client machine 140, a database external to the network-based publication system 120 (e.g., hosted by a third-party server machine), or any suitable combination thereof.

In operation 930, the access module 210 of the content machine 110 accesses the social network data 610, which was received in operation 910. According to various example embodiments in which operation 910 is omitted, operation 930 involves accessing the social network data 610 from the database 122, the network-based publication system 120, the client machine 140, a database external to the network-based publication system 120 (e.g., hosted by a third-party server machine), or any suitable combination thereof.

In operation 940, the access module 210 of the content machine 110 accesses a transactional record (e.g., transactional record 510) of the particular user (e.g., the first user) of the network-based publication system 120. In operation 950, the access module 210 accesses a further transactional record (e.g., a transactional record similar to transactional record 510) of the further user (e.g., the second user) of the network-based publication system 120. One or more of these transactional records may be accessed from the database 122, the network-based publication system 120, the client machine 140, or any suitable combination thereof.

In operation 960, the access module 210 of the content machine 110 accesses the client location data 430. The client location data 430 may be accessed from the database 122, the network-based publication system 120, the client machine 140, or any suitable combination thereof.

In operation 970, the access module 210 of the content machine 110 accesses the merchandising data 740. The merchandising data 740 may be determined by the network-based publication system 120. For example, the network-based publication system 120 may access some or all of the information accessed by the access module 210 of the content machine 110. According to various example embodiments, network-based publication system 120 accesses promotional information pertinent to items listed as being available for purchase (e.g., inventory data, special pricing, discounts, coupons, or other buyer incentives). As noted above, the merchandising data may include the item name 750 of an item listed by the network-based publication system 120 and may include at least one of the event name 310 or the event date 320, thus relating the item name 750 to the event name 310 or the event date 320. The merchandising data 740 may be accessed from the database 122, the network-based publication system 120, or any suitable combination thereof.

In operation 980, the generation module 220 of the content machine 110 generates the content (e.g., content 700 or content 800) for the particular user (e.g., the first user) of the network-based publication system 120. The generation of the content is based on some or all of the information accessed by the access module 210 in performing operations 910-970. Moreover, the content generated may include some or all of the information accessed by the access module 210.

In operation 990, the provision module 230 of the content machine 110 provides the content (e.g., content 700 or content 800) to the client machine 140 for presentation to the particular user of the network-based publication system 120. The content is provided via the network 130, via the network-based publication system 120, or any suitable combination thereof. The content may be provided in one or more network communications and may be provided over a period of time (e.g., updated).

According to various example embodiments, one or more of the methodologies described herein may facilitate a user experience describable as enhanced, personalized, or customized for the particular user of the network-based publication system 120. The content (e.g., content 700 or content 800) provided to the client machine 140 may be deemed by the particular user as especially relevant, useful, or interesting. Accordingly, one or more of the methodologies discussed herein may obviate a need for additional searching for information (e.g., web searches), which may have the technical effect of reducing computing resources used by one or more devices within the system 100. Examples of such computing resources include, without limitation, processor cycles, network traffic, memory usage, storage space, and power consumption.

FIG. 10 illustrates components of a machine 1000, according to some example embodiments, that is able to read instructions from a machine-readable medium (e.g., machine-readable storage medium) and perform any one or more of the methodologies discussed herein. Specifically, FIG. 10 shows a diagrammatic representation of the machine 1000 in the example form of a computer system and within which instructions 1024 (e.g., software) for causing the machine 1000 to perform any one or more of the methodologies discussed herein may be executed. In alternative embodiments, the machine 1000 operates as a standalone device or may be connected (e.g., networked) to other machines. In a networked deployment, the machine 1000 may operate in the capacity of a server machine or a client machine in a server-client network environment, or as a peer machine in a peer-to-peer (or distributed) network environment. The machine 1000 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1024 (sequentially or otherwise) that specify actions to be taken by that machine. Further, while only a single machine is illustrated, the term “machine” shall also be taken to include a collection of machines that individually or jointly execute the instructions 1024 to perform any one or more of the methodologies discussed herein.

The machine 1000 includes a processor 1002 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1004, and a static memory 1006, which are configured to communicate with each other via a bus 1008. The machine 1000 may further include a graphics display 1010 (e.g., a plasma display panel (PDP), a liquid crystal display (LCD), a projector, or a cathode ray tube (CRT)). The machine 1000 may also include an alphanumeric input device 1012 (e.g., a keyboard), a cursor control device 1014 (e.g., a mouse, a touchpad, a trackball, a joystick, a motion sensor, or other pointing instrument), a storage unit 1016, a signal generation device 1018 (e.g., a speaker), and a network interface device 1020.

The storage unit 1016 includes a machine-readable medium 1022 on which is stored the instructions 1024 (e.g., software) embodying any one or more of the methodologies or functions described herein. The instructions 1024 may also reside, completely or at least partially, within the main memory 1004, within the processor 1002 (e.g., within the processor's cache memory), or both, during execution thereof by the machine 1000. Accordingly, the main memory 1004 and the processor 1002 may be considered as machine-readable media. The instructions 1024 may be transmitted or received over a network 1026 (e.g., network 130) via the network interface device 1020.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1022 is shown in an example embodiment to be a single medium, the term “machine-readable medium” should be taken to include a single medium or multiple media (e.g., a centralized or distributed database, or associated caches and servers) able to store instructions (e.g., instructions 1024). The term “machine-readable medium” shall also be taken to include any medium that is capable of storing instructions (e.g., software) for execution by the machine, such that the instructions, when executed by one or more processors of the machine (e.g., processor 1002), cause the machine to perform any one or more of the methodologies described herein. The term “machine-readable medium” shall accordingly be taken to include, but not be limited to, a data repository in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A computer-implemented method comprising:
accessing event data relevant to a user of a network-based publication system, the event data referencing an event to occur on an event date, the event data including the event date and an event name of the event;
accessing a transactional record of the network-based publication system, the transaction record including purchase data of the user, the purchase data being generated by the network-based publication system in facilitating a purchase of an item by the user, the purchase data including a reference to the item;
generating content based on at least some of the event data and based on at least some of the purchase data of the user, the content including at least some of the event data, the generating of the content being performed by a module implemented using a processor of a machine; and
providing the content to a client machine of the user, the client machine being configured to present the content to the user.

2. The computer-implemented method of claim 1, wherein
at least one of the generating of the content or the providing of the content is based on at least one of the event name or the event date.

3. The computer-implemented method of claim 1, wherein
the content includes at least one of the event name, the event date, or the reference to the item.

4. The computer-implemented method of claim 1, wherein:
the user is a first user of the network-based publication system; and the method further comprises
accessing social network data of the first user, the social network data including a reference to a second user of the network-based publication system, the second user being distinct from the first user; wherein
at least one of the generating of the content or the providing the content is based on the social network data of the first user; and
the content includes the reference to the second user.

5. The computer-implemented method of claim 4, wherein
the content includes a suggestion that a further item pertinent to the event be purchased as a gift for the second user by the first user.

6. The computer-implemented method of claim 4, wherein:
the transactional record is a first transactional record;
the purchase data is first purchase data;
the network-based publication system includes a user database that stores a second transactional record of the network-based publication system, the second transactional record including second purchase data of the second user, the second purchase data being generated by the network-based publication system in facilitating a purchase of a further item by the second user, the second purchase data including a reference to the further item; and the method further comprises
accessing the second transactional record; wherein
the generating of the content is based on at least some of the second purchase data.

7. The computer-implemented method of claim 1 further comprising:
accessing merchandising data that references a further item listed by the network-based publication system, the merchandising data including an item name of the further item and including at least one of the event name or the event date; and wherein
the generating of the content is based on the merchandising data; and
the content includes the item name of the further item.

8. The computer-implemented method of claim 1, wherein:
the event data includes event location data that identifies a geographical location corresponding to the event;
the event location data includes at least one of: a street name, a city name, a venue name, a neighborhood name, a latitude value, or a longitude value; and
at least one of the generating of the content or the providing of the content is based on the event location data.

9. The computer-implemented method of claim 8 further comprising:
accessing client location data that identifies a further geographical location corresponding to the client machine, the client location data including at least one of: the street name, the city name, the venue name, the neighborhood name, a further latitude value, or a further longitude value; wherein
at least one of the generating of the content or the providing of the content is based on the client location data.

10. The computer-implemented method of claim 9, wherein:
the content includes at least one of the event location data or the client location data.

11. The computer-implemented method of claim 1, wherein:
the event is at least one of: a public event, a private event, a personal event, an educational event, an entertainment event, a religious event, a sports event, an astronomical event, a transportation event, a calendar event.

12. The computer-implemented method of claim 1, wherein:
the event corresponds to at least one of: a holiday, a birthday, anniversary, a deadline, a meeting, an appointment, a lecture, a concert, a festival, an arrival, a departure, or a religious ritual.

13. The computer-implemented method of claim 1, wherein:
the item is a specimen of a product presented by the network-based publication system as being available for purchase.

14. The computer-implemented method of claim 1, wherein:
the content includes a component comprising at least one of:
a web portal including references to a plurality of documents available from the network-based publication system;
a virtual assistant operable using the client machine to facilitate a selection from among a plurality of items listed by the network-based publication system;
an advertisement including merchandising data that references a further item of the plurality of items listed by the network-based publication system; and
an electronic storefront operable using the client machine to facilitate a further purchase of the further item.

15. A system comprising:
an access module configured to:
access event data relevant to a user of a network-based publication system, the event data referencing an event to occur on an event date, the event data including the event date and an event name of the event;
access a transactional record of the network-based publication system, the transaction record including purchase data of the user, the purchase data being generated by the network-based publication system in facilitating a purchase of an item by the user, the purchase data including a reference to the item;
a hardware-implemented generation module configured to generate content based on at least some of the event data and based on at least some of the purchase data of the user, the content including at least some of the event data; and
a provision module configured to provide the content to a client machine of the user, the client machine being configured to present the content to the user.

16. The system of claim 15, wherein:
the generation module is configured to generate the content based on at least one of the event name or the event date; and
the content includes at least one of the event name, the event date, or the reference to the item.

17. The system of claim 15, wherein:
the user is a first user of the network-based publication system;
the access module is configured to access social network data of the first user, the social network data including a reference to a second user of the network-based publication system, the second user being distinct from the first user;
the generation module is configured to generate the content based on the social network data of the first user; and
the content includes the reference to the second user.

18. The system of claim 17, wherein:
the transactional record is a first transactional record;
the purchase data is first purchase data;
the network-based publication system includes a user database that stores a second transactional record of the network-based publication system, the second transactional record including second purchase data of the second user, the second purchase data being generated by the network-based publication system in facilitating a purchase of a further item by the second user, the second purchase data including a reference to the further item;
the access module is configured to access the second transactional record; and
the generation module is configured to generate the content based on at least some of the second purchase data.

19. The system of claim 15, wherein:
the event data includes event location data that identifies a geographical location corresponding to the event;
the event location data includes at least one of: a street name, a city name, a venue name, a neighborhood name, a latitude value, or a longitude value;
the access module is configured to access client location data that identifies a further geographical location corresponding to the client machine, the client location data including at least one of: the street name, the city name, the venue name, the neighborhood name, a further latitude value, or a further longitude value; and
the generation module is configured to generate the content based on at least one of the event location data or the client location data.

20. A non-transitory machine-readable storage medium comprising instructions that, when executed by one or more processors of a machine, cause the machine to perform a method comprising:
accessing event data relevant to a user of a network-based publication system, the event data referencing an event to occur on an event date, the event data including the event date and an event name of the event;
accessing a transactional record of the network-based publication system, the transaction record including purchase data of the user, the purchase data being generated by the network-based publication system in facilitating a purchase of an item by the user, the purchase data including a reference to the item;
generating content based on at least some of the event data and based on at least some of the purchase data of the user, the content including at least some of the event data; and
providing the content to a client machine of the user, the client machine being configured to present the content to the user.
